(19) United States
(12) Patent Application Publication
(10) Pub. No.: US 2024/0217559 A1
(43) Pub. Date: Jul. 4, 2024

(54) SMART VEHICLE-ORIENTED METHOD AND SYSTEM FOR COLLABORATIVE DISPATCHING OF DRIVING INTENTS IN AREA

(71) Applicant: GUANGZHOU UNIVERSITY, Guangzhou, Guangdong (CN)

(72) Inventors: Ke QI, Guangzhou, Guangdong (CN); Wenkang LI, Guangzhou, Guangdong (CN)

(21) Appl. No.: 18/549,989

(22) PCT Filed: Aug. 23, 2021
(86) PCT No.: PCT/CN2021/113984

§ 371 Date: Sep. 11, 2023

(30) Foreign Application Priority Data
Oct. 15, 2020 (CN) 202011102809.7

(51) Int. Cl. B60W 60/00; G06N 3/0464

(52) U.S. Cl. CPC B60W 60/00276; B60W 60/0015; G06N 3/0464

(57) ABSTRACT

A smart vehicle-oriented method and system for collaborative dispatching of driving intents in an area, and a medium. The method includes acquiring state and position information and driving intention information of vehicles in a dis-patching area range, and generating a global graph of the driving intentions of all the vehicles on the basis of the state and position information and driving intention information of the vehicles in the dispatching area range; constructing a dispatching area occupancy grid map model; according to the constructed dispatching area occupancy grid map model performing collaborative dispatching on the global driving intentions of the vehicles in the area range, generating a global dispatching result of the driving intentions of the vehicles; and guiding the driving decisions of the vehicles within the dispatching area range by means of the global dispatching result of the driving intentions of the vehicles within the dispatching area range.

### FIELD OF THE INVENTION

The present disclosure relates to the field of intelligent vehicle control, and more particularly, to a method and system for regionally co-dispatching driving intentions of intelligent vehicles, and a medium.

### BACKGROUND OF THE INVENTION

The development of intelligent driving is conducive to the improvement of the level of road traffic intelligence and the promotion of the transformation and upgrading of transportation industry. The intelligent driving in a human-vehicle co-driving mode is the mainstream mode of intelligent traffic before unmanned driving is fully safe and available. In this mode, the vehicle control right can be transferred between a person and a vehicle, and a driver can take over the vehicle control at any time and issue a vehicle control command.

When an intelligent vehicle drives autonomously, the intelligent vehicle collects and recognizes environmental information in real time through a perception device, and then makes driving decisions according to the environmental information. However, due to the diversity of driving scenarios and the diversity of driving habits of drivers, drivers may change their driving intentions at any time, take over vehicle control, and control vehicles to perform actions such as speeding up, slowing down, traveling at a constant speed, and traveling to another lane. Such behavior of suddenly changing driving intentions will seriously affect the driving safety. Especially in a traffic environment with a large traffic flow, multiple drivers change their driving intentions at the same time, thereby easily causing conflict of vehicle driving intentions of drivers within adjacent area ranges, and reducing the overall driving efficiency within the area ranges. For example, both a vehicle under test and vehicles within adjacent area ranges drive autonomously, a safe distance and a safe speed are kept between the vehicles, and the lateral and longitudinal motion states (position and speed) of the vehicles are matched. At this moment, if the driver of the vehicle under test adopts a sudden lane change strategy, the driver of a rear vehicle in a target lane adopts a sudden speed-up driving strategy, and the driver of a front vehicle in the target lane adopts a sudden slow-down driving strategy, the vehicle under test may collide with both the front and rear vehicles in the target lane.

At present, the intelligent driving monitors the driving intentions of vehicles in the vicinity of the current vehicle through vehicle-to-vehicle communication and V2X technology. However, the vehicle-to-vehicle communication and V2X technology cannot realize the global perception and co-dispatching of driving intentions of all vehicles within a certain area range. Therefore, it is necessary to co-dispatch the driving intentions of the vehicles within the certain area range for intelligent driving in the scenario of a human-vehicle co-driving mode, and then guide vehicle driving decisions according to the sequence of the co-dispatched driving intentions of the vehicles, so as to make the vehicle safely travel in sequence and improve the intelligent driving safety and traffic efficiency in the human-vehicle co-driving mode.

### SUMMARY OF THE INVENTION

In view of the disadvantages and shortcomings of the related art, a first object of the present disclosure is to provide a method for regionally co-dispatching driving intentions of intelligent vehicles. According to the method, driving intentions of all vehicles within a area range can be co-dispatched, and a global dispatching result can be generated to guide driving decisions of the vehicles. On the one hand, the risk of collision of the vehicles is avoided, thereby improving the driving safety. On the other hand, the overall traffic efficiency within an area range is also improved.

A second object of the present disclosure is to provide an apparatus for regionally co-dispatching driving intentions of intelligent vehicles.

A third object of the present disclosure is to provide a system for regionally co-dispatching driving intentions of intelligent vehicles.

A fourth object of the present disclosure is to provide a storage medium.

A fifth object of the present disclosure is to provide a computing device.

The first object of the present disclosure is achieved by the following technical solution: a method for regionally co-dispatching driving intentions of intelligent vehicles includes:
acquiring state information and position information of vehicles;
acquiring driving intention information of the vehicles recognized by the state information of the vehicles;
generating a global driving intention graph of all the vehicles within a dispatching area range according to the driving intention information of the vehicles within the dispatching area range, the state information of the vehicles and the position information of the vehicles;
constructing a dispatching area occupancy grid map model; and
co-dispatching global driving intentions of the vehicles within the area range according to the constructed dispatching area occupancy grid map model, and generating a global dispatching result of driving intentions of dispatching area vehicles, so as to guide driving decisions of the vehicles within the dispatching area range by means of the global dispatching result of driving intentions of dispatching area vehicles.

Preferably, the process of recognizing the driving intentions of the vehicles through the state information and position information of the vehicles includes:
constructing a driving intention recognition model based on a convolutional neural network, wherein vehicle state information is taken as an input quantity I of the driving intention recognition model, and a recognition vector w=(w1, w2, w3, w4, w5) for the driving intentions is output by a Softmax layer of the driving intention recognition model, where w1, w2, w3, w4, and w5 are probabilities of driving intention categories: traveling to a left lane, keeping unchanged, traveling to a right lane, speeding up, and slowing down, respectively; and setting confidence thresholds for various driving intention categories, and when an output probability of a certain driving intention category is greater than the corresponding confidence threshold, determining that a vehicle has a driving intention C corresponding to the category, where
C∈{Ca: traveling to a left lane, Cb: keeping unchanged, Cc: traveling to a right lane, Cd: speeding up, Cf: slowing down}.

Preferably, the generating a global driving intention graph of all the vehicles within a dispatching area range is: G=[gᵢ], 1≤i≤N, N is a total number of vehicles within the dispatch area range, where 81=(Cᵢ, Vᵢ, Wᵢ, Pᵢ), and Cᵢ, Vᵢ, Wᵢ, Pᵢ are the driving intention, absolute speed, steering angle, and vehicle position information of an i^{th} vehicle within the dispatching area range, respectively.

Furthermore, the process of generating the global dispatching result of driving intentions of dispatching area vehicles is as follows:
Sa, representing position information Pᵢ of each vehicle i within the dispatching area range with point coordinates based on the dispatching area occupancy grid map model, 1≤i≤N, mapping into a corresponding cell of an occupancy grid, identifying a cell mapped with vehicle position information as occupancy, and identifying a cell not mapped with vehicle position information as vacancy;
Sb, calculating a longitudinal displacement S′ᵢ=(Vᵢtₛ+1/2=aₛtₛ²) cos(Wᵢ) and a lateral displacement S′ᵢ=(Vᵢtₛ+1/2=aₛtₛ²) sin(Wᵢ) of each vehicle i within a safe acceleration aₛ and a safe time tₛ according to the driving intention Cᵢ, absolute speed Vᵢ and steering wheel angle Wᵢ of each vehicle i within the dispatching area, and determining predicted position information Pᵢ^{ts} of the vehicle i according to the longitudinal displacement S′ᵢ and the lateral displacement S′ᵢ, 1≤i≤N;
Sc, acquiring a prediction state according to the predicted position information Pᵢ^{ts} of each vehicle i within the dispatching area for each cell in the dispatching area;

Sd, predicting, based on the prediction state of each cell, whether the driving intentions of the vehicles conflict in the cell, specifically:
determining whether the prediction state of each cell is occupancy by multiple vehicles, when the prediction state of a cell is occupancy by a vehicle, namely, when the cell is predicted to be occupied by a vehicle, predicting that the driving intentions of the vehicle do not conflict in the cell, and controlling the vehicle predicted to occupy the cell to travel according to the driving intentions thereof;
when the prediction state of a cell is occupancy by multiple vehicles, namely, when the cell is predicted to be occupied by multiple vehicles, predicting that the driving intentions of the vehicle conflict in the cell, and proceeding to step Se;
Se, determining whether the multiple vehicles predicted to occupy the cell have a driving intention: keeping unchanged;
if yes, setting the driving intentions of all the vehicles predicted to occupy the cell as: keeping unchanged;
if no, randomly selecting a vehicle from the multiple vehicles predicted to occupy the cell to travel according to the driving intention thereof, and setting the driving intentions of the other vehicles as: keeping unchanged;
Sf, determining the driving intentions of the vehicles within the dispatching area based on the above operations, and generating a dispatching result.

The second object of the present disclosure is achieved by the following technical solution: an apparatus for regionally co-dispatching driving intentions of intelligent vehicles includes:
an information acquisition module, configured to acquire state information and position information of vehicles, and acquire driving intentions of the vehicles recognized by the state information and position information of the vehicles;
a global driving intention graph generation module, configured to generate a global driving intention graph of all the vehicles within a dispatching area range according to the driving intention information of the vehicles within the dispatching area range, the state information of the vehicles and the position information of the vehicles;
a map model construction module, configured to construct a dispatching area occupancy grid map model; and
a global dispatching result generation module, configured to co-dispatch global driving intentions of the vehicles within the area range according to the constructed dispatching area occupancy grid map model, and generate a global dispatching result of driving intentions of dispatching area vehicles, so as to guide driving decisions of the vehicles within the dispatching area range by means of the global dispatching result of driving intentions of dispatching area vehicles.

The third object of the present disclosure is achieved by the following technical solution: a system for regionally co-dispatching driving intentions of intelligent vehicles includes a cloud dispatching system, and a vehicle-mounted driving intention perception system and a vehicle-mounted driving intention control system disposed on a vehicle.

The vehicle-mounted driving intention perception system is connected to the vehicle-mounted driving intention control system, and is configured to acquire state information and position information of the vehicle and transmit the acquired state information and position information of the vehicle to the vehicle-mounted driving intention control system.

The vehicle-mounted driving intention control system is connected to the cloud dispatching system in a wireless manner, and is configured to recognize a driving intention of the vehicle according to the state information of the vehicle, and transmit the driving intention information of the vehicle and the state information and position information of the vehicle to the cloud dispatching system.

The cloud dispatching system is configured to perform the method for regionally co-dispatching driving intentions of intelligent vehicles described in the first object of the present disclosure.

Preferably, the vehicle-mounted driving intention perception system includes a vehicle state acquisition unit and a positioning unit.

The vehicle state acquisition unit is configured to acquire the state information of the vehicle, including an accelerator pedal state, steering wheel angle, brake pedal state, and absolute speed of the vehicle.

The positioning unit is configured to acquire the position information of the vehicle, including GPS longitude information and GPS latitude information of the vehicle.

Preferably, the vehicle-mounted driving intention control system includes a driving intention recognition unit, a communication unit and an output unit.

The driving intention recognition unit is configured to acquire the driving intention of the vehicle recognized according to the state information of the vehicle.

The communication unit is configured to transmit the driving intention information of the vehicle and the state information and position information of the vehicle to the cloud dispatching system.

The output unit is configured to receive a global dispatching result of driving intentions of driving dispatching area vehicles transmitted by the cloud dispatching system, whereby a vehicle driving decision system guides driving decisions of the vehicle according to the dispatching result.

The cloud dispatching system includes a cloud communication server and a cloud co-dispatching server.

The cloud co-dispatching server is configured to perform the method for regionally co-dispatching driving intentions of intelligent vehicles described in the first object of the present disclosure.

The cloud communication server is configured to communicate with the communication unit in the vehicle-mounted driving intention control system, receive the driving intention information of the vehicle and the state information and position information of the vehicle transmitted by the vehicle-mounted driving intention control system, and transmit the global dispatching result of driving intentions of driving dispatching area vehicles to the vehicle-mounted driving intention control system.

The fourth object of the present disclosure is achieved by the following technical solution: a storage medium stores a program which, when executed by a processor, implements the method for regionally co-dispatching driving intentions of intelligent vehicles described in the first object of the present disclosure.

The fifth object of the present disclosure is achieved by the following technical solution: a computing device includes a processor and a memory for storing a program executable by the processor. The processor, when executing the program stored in the memory, implements the method for regionally co-dispatching driving intentions of intelligent vehicles described in the first object of the present disclosure.

The present disclosure has the following advantages and effects in contrast to the related art:

(1) The method for regionally co-dispatching driving intentions of intelligent vehicles according to the present disclosure includes: first, acquiring state information, position information and driving intention information of vehicles within a dispatching area range, and generating a global driving intention graph of all the vehicles within the dispatching area range based on the state information, position information and driving intention information of the vehicles within the dispatching area range; then, constructing a dispatching area occupancy grid map model; and co-dispatching global driving intentions of the vehicles within the area range according to the constructed dispatching area occupancy grid map model, and generating a global dispatching result of driving intentions of dispatching area vehicles, so as to guide driving decisions of the vehicles within the dispatching area range by means of the global dispatching result of driving intentions of dispatching area vehicles. As can be seen from the above, global driving intentions of vehicles within a area range are co-dispatched based on a dispatching area occupancy grid map model, driving intentions of vehicles within a dispatching area range can be comprehensively dispatched and controlled, and a global dispatching result is generated to guide driving decisions of the vehicles. On the one hand, the risk of collision of the vehicles is avoided, thereby improving the driving safety. On the other hand, the overall traffic efficiency within a area range is also improved.

(2) In the method for regionally co-dispatching driving intentions of intelligent vehicles according to the present disclosure, a driving intention recognition model is constructed based on a convolutional neural network model, and then the driving intentions of the vehicles are recognized based on vehicle state information by the driving intention recognition model, so that the driving intentions of the vehicles can be accurately recognized.

(3) In the method for regionally co-dispatching driving intentions of intelligent vehicles according to the present disclosure, when a dispatching result is generated, a dispatching area occupancy grid map model is constructed, predicted position information of the vehicles is determined according to the driving intentions of the vehicles in the dispatching area, and a prediction state of cells can be determined based on the predicted position information of the vehicles, so as to predict vehicles that will occupy the cells. When there are two or more vehicles occupying the cells, driving of the vehicles can be dispatched by controlling the driving intentions of the vehicles. Therefore, based on the dispatching area occupancy grid map model, the method of the present disclosure can realize the unified dispatching of the driving intentions of vehicles within a dispatching area range, control the driving intentions of all the vehicles within the dispatching range, and effectively avoid the phenomenon that multiple vehicles arrive at the same cell simultaneously and collide with each other.

(4) The system for regionally co-dispatching driving intentions of intelligent vehicles according to the present disclosure includes a cloud dispatching system, and a vehicle-mounted driving intention perception system and a vehicle-mounted driving intention control system disposed on a vehicle. In the system, the vehicle-mounted driving intention perception system on each vehicle collects state information and position information of the vehicle, and the vehicle-mounted driving intention control system on each vehicle recognizes a driving intention of the vehicle based on the state of the vehicle, and finally transmits the driving intention information of the vehicle and the state information and position information of the vehicle to the cloud dispatching system. The cloud dispatching system generates a global dispatching result of driving intentions of dispatching area vehicles and transmits the dispatching result to the vehicle-mounted driving intention control system, whereby the vehicle travels based on the dispatching result transmitted by the cloud dispatching system. As can be seen from the above, vehicles can be globally controlled within an area range based on the cloud dispatching system, the collision between the vehicles can be effectively avoided in an intelligent driving mode under a human-vehicle co-driving mode scenario, and the intelligent driving safety and traffic efficiency in the human-vehicle co-driving mode are improved.

### BRIEF DESCRIPTION OF THE DRAWINGS

FIG. 1 is a flowchart of a method for regionally co-dispatching driving intentions of intelligent vehicles according to the present disclosure.

FIG. 2 is a linear area occupancy grid map model established in the method of the present disclosure.

FIG. 3 is a bending area occupancy grid map model established in the method of the present disclosure.

FIG. 4 is a structural block diagram of an apparatus for regionally co-dispatching driving intentions of intelligent vehicles according to the present disclosure.

FIG. 5 is a structural block diagram of a system for regionally co-dispatching driving intentions of intelligent vehicles according to the present disclosure.

### DETAILED DESCRIPTION OF THE EMBODIMENTS

The present disclosure will be described below in further detail with reference to embodiments and drawings, but implementations of the present disclosure are not limited thereto.

### Embodiment 1

The present embodiment discloses a method for regionally co-dispatching driving intentions of intelligent vehicles. The method can avoid the risk of vehicle conflict and improve the driving safety when used in intelligent driving adopting a human-vehicle co-driving mode.

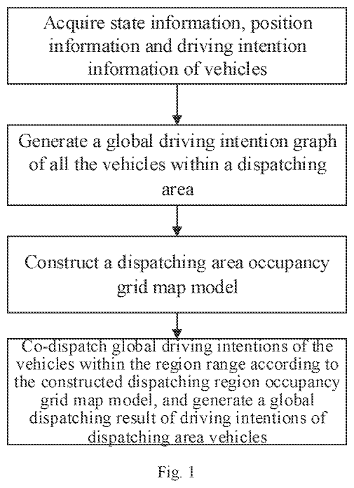

The method can also improve the overall traffic efficiency within a area range. The specific process of the method is as shown in FIG. 1, including:

At S1, state information and position information of vehicles are acquired, and driving intention information of the vehicles recognized by the state information of the vehicles is also acquired. In the present embodiment, the acquired vehicle state information specifically includes an accelerator pedal state, steering wheel angle, brake pedal state, and absolute speed of the vehicle.

The process of recognizing driving intention information of the vehicles by the state information of the vehicles may include the following steps:

At S11, a driving intention recognition model is constructed based on a convolutional neural network (CNN). Vehicle state information is taken as an input quantity I of the driving intention recognition model, and a recognition vector w=(w1, w2, w3, w4, w5) for the driving intentions is output by a Softmax layer of the driving intention recognition model, where w1, w2, w3, w4, and w5 are probabilities of driving intention categories: traveling to a left lane, keeping unchanged, traveling to a right lane, speeding up, and slowing down, respectively.

At S12, confidence thresholds for various driving intention categories are set, the acquired current vehicle state information is input into the driving intention recognition model, and when an output probability of a certain driving intention category is greater than the corresponding confidence threshold, it is determined that a vehicle has a driving intention C corresponding to the category, where

C∈{Ca: traveling to a left lane, Cb: keeping unchanged, Cc: traveling to a right lane, Cd: speeding up, Cf: slowing down}.

In the present embodiment, the confidence thresholds for the driving intention categories: traveling to a left lane and traveling to a right lane are set as 80%, the confidence threshold for the driving intention category: keeping unchanged is set as 70%, and the confidence thresholds for the driving intention categories: speeding up and slowing down are set as 80%.

At S2, a global driving intention graph of all the vehicles within a dispatching area range is generated according to the driving intention information of the vehicles within the dispatching area range, the state information of the vehicles and the position information of the vehicles. In the present embodiment, the generating a global driving intention graph of all the vehicles within a dispatching area range is: G=[gᵢ], 1≤i≤N, N is a total number of vehicles within the dispatch area range, where gᵢ=(Cᵢ, Vᵢ, Wᵢ, Pᵢ), and Cᵢ, Vᵢ, Wᵢ, Pᵢ are the driving intention, absolute speed, steering angle, and vehicle position information of an i^{th} vehicle within the dispatching area range, respectively.

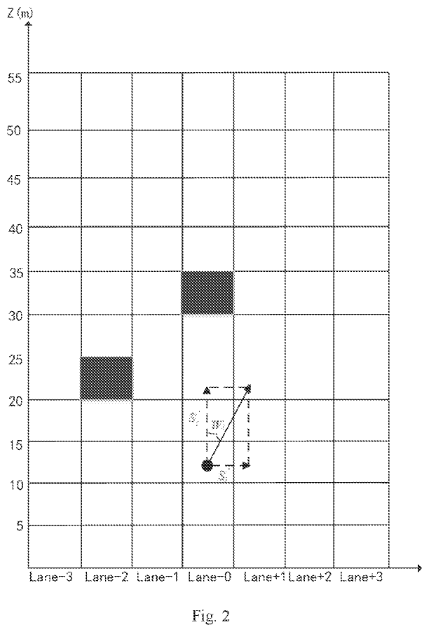

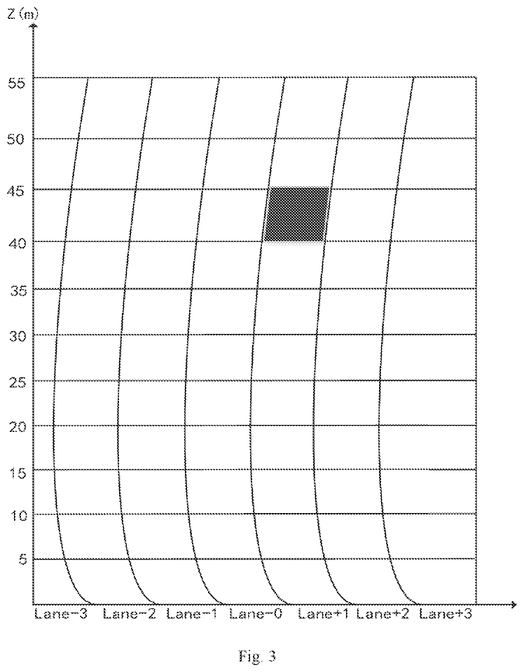

At S3, a dispatching area occupancy grid map model is constructed. In the present embodiment, the dispatching area occupancy grid map model equally divides an area obtained by dividing lane lines, and each cell obtained is referred to as a cell. In the present embodiment, the longitudinal length of the cell is set as 5 m, and the lateral width defaults to a single lane width. As shown in FIG. 2, each cell is approximated as a rectangle for a straight lane. As shown in FIG. 3, each cell may be approximated as a convex quadrilateral for a bending lane, the coordinates of one cell are determined with every four vertex coordinates, and four line segments connecting four vertices are taken as a range of one cell. If the vehicle is located within the range of a certain cell, the state of the cell is identified as occupancy. As shown in the filled-in parts of FIGS. 2 and 3, the state of the other unoccupied cells is identified as vacancy.

At S4, global driving intentions of the vehicles within the area range are co-dispatched according to the constructed dispatching area occupancy grid map model, and a global dispatching result of driving intentions of dispatching area vehicles is generated, so as to guide driving decisions of the vehicles within the dispatching area range by means of the global dispatching result of driving intentions of dispatching area vehicles R=[Cᵢ], 1≤i≤N.

In the present embodiment, the process of generating the global dispatching result of driving intentions of dispatching area vehicles in step S4 is as follows:

At Sa, position information Pᵢ of each vehicle i within the dispatching area range is represented with point coordinates based on the dispatching area occupancy grid map model, 1≤i≤N, and mapped into a corresponding cell of the occupancy grid map model, a cell mapped with vehicle position information is identified as occupancy, and a cell not mapped with vehicle position information is identified as vacancy.

At Sb, a longitudinal displacement S′ᵢ=(Vᵢtₛ+1/2=aₛtₛ²) cos(Wᵢ) and a lateral displacement S′ᵢ=(Vᵢtₛ+1/2=aₛtₛ²) sin(Wᵢ) of each vehicle i within a safe acceleration aₛ and a safe time tₛ are calculated according to the driving intention Cᵢ, absolute speed Vᵢ and steering wheel angle Wᵢ of each vehicle i within the dispatching area, and predicted position information Pᵢ^{ts} of the vehicle i is determined according to the longitudinal displacement S′ᵢ and the lateral displacement S′ᵢ, 1≤i≤N.

In the present embodiment, a current position of each vehicle in the occupancy grid model is determined based on the position information. Therefore, a predicted position of the vehicle can be obtained based on the above-described longitudinal displacement S′ᵢ and lateral displacement S′ᵢ information as shown in FIG. 2.

At Sc, a prediction state is acquired according to the predicted position information Pᵢ^{ts} of each vehicle i within the dispatching area for each cell in the dispatching area. For each cell, when it is predicted that the vehicle i will arrive at the cell according to the predicted position information Pᵢ^{ts} of the vehicle i, the prediction state of the cell is identified as being occupied by the vehicle i, and when it is predicted that multiple vehicles will arrive at the cell according to the predicted position information of each vehicle, the prediction state of the cell is identified as being occupied by each of the multiple vehicle. For example, for a certain cell, when it is predicted that vehicle a1 will arrive at the cell according to the predicted position information of each vehicle, the prediction state of the cell is identified as being occupied by vehicle a1, and when it is predicted that vehicles a1, a2 and a3 will arrive at the cell according to the predicted position information of each vehicle, the prediction state of the cell is identified as being occupied by vehicles a1, a2 and a3.

At Sd, it is predicted, based on the prediction state of each cell, whether the driving intentions of the vehicles conflict in the cell, specifically:

It is determined whether the prediction state of each cell is occupancy by multiple vehicles.

When the prediction state of a cell is occupancy by a vehicle, namely, when the cell is predicted to be occupied by a vehicle, it is predicted that the driving intentions of the vehicle do not conflict in the cell. At this moment, the vehicle predicted to occupy the cell is controlled to travel according to the driving intentions thereof.

When the prediction state of a cell is occupancy by multiple vehicles, namely, when the cell is predicted to be occupied by multiple vehicles, it is predicted that the driving intentions of the vehicle conflict in the cell. At this moment, the process proceeds to step Se.

At Se, it is determined whether the multiple vehicles predicted to occupy the cell have a driving intention: keeping unchanged.

If yes, the driving intentions of all the vehicles predicted to occupy the cell are set as: keeping unchanged.

If no, a vehicle is randomly selected from the multiple vehicles predicted to occupy the cell to travel according to the driving intention thereof, and the driving intentions of the other vehicles are all set as: keeping unchanged. The driving intentions of the vehicles, keeping unchanged, mean that the vehicles travel according to the original driving state.

At Sf, the driving intentions Cᵢ of the vehicles within the dispatching area are determined based on the above operations, and a dispatching result R=[Cᵢ] is generated, 1≤i≤N.

In the present embodiment, based on the operations of steps Sa to Sf, only one of vehicles predicted to arrive at the same cell at the next time can eventually arrive at the cell, thereby effectively avoiding a collision traffic accident caused by two or more vehicles arriving at the same cell at the same time.

Those skilled in the art will appreciate that all or part of the steps in implementing the method of the present embodiment may be completed by a program that instructs associated hardware, and that the corresponding program may be stored in a computer-readable storage medium. It should be noted that although the method operations of Embodiment 1 are depicted in the drawings in a particular order, this does not require or imply that the operations must be performed in the particular order, or that all of the illustrated operations must be performed to achieve the desired results. Rather, the depicted steps may change the order of execution and some steps may be executed concurrently. Additionally or alternatively, certain steps may be omitted, multiple steps may be combined into one step for execution, and/or one step may be decomposed into multiple steps for execution.

### Embodiment 2

The present embodiment discloses an apparatus for regionally co-dispatching driving intentions of intelligent vehicles. As shown in FIG. 4, the apparatus includes an information acquisition module, a global driving intention graph generation module, a map model construction module, and a global dispatching result generation module. The functions realized by various modules are respectively as follows:

The information acquisition module is configured to acquire state information and position information of vehicles, and acquire driving intentions of the vehicles recognized by the state information and position information of the vehicles.

The global driving intention graph generation module is configured to generate a global driving intention graph of all the vehicles within a dispatching area range according to the driving intention information of the vehicles within the dispatching area range, the state information of the vehicles and the position information of the vehicles.

The map model construction module is configured to construct a dispatching area occupancy grid map model.

The global dispatching result generation module is configured to co-dispatch global driving intentions of the vehicles within the area range according to the constructed dispatching area occupancy grid map model, and generate a global dispatching result of driving intentions of dispatching area vehicles, so as to guide driving decisions of the vehicles within the dispatching area range by means of the global dispatching result of driving intentions of dispatching area vehicles.

The specific implementation of each of the above-mentioned modules in the present embodiment may be seen in Embodiment 1, and detailed descriptions thereof will be omitted herein. It should be noted that the apparatus provided in the present embodiment is merely exemplified by the division of the above-mentioned functional modules, and in practical applications, the above-mentioned functional allocation may be performed by different functional modules according to needs, namely, the internal structure is divided into different functional modules so as to perform all or part of the functions described above.

### Embodiment 3

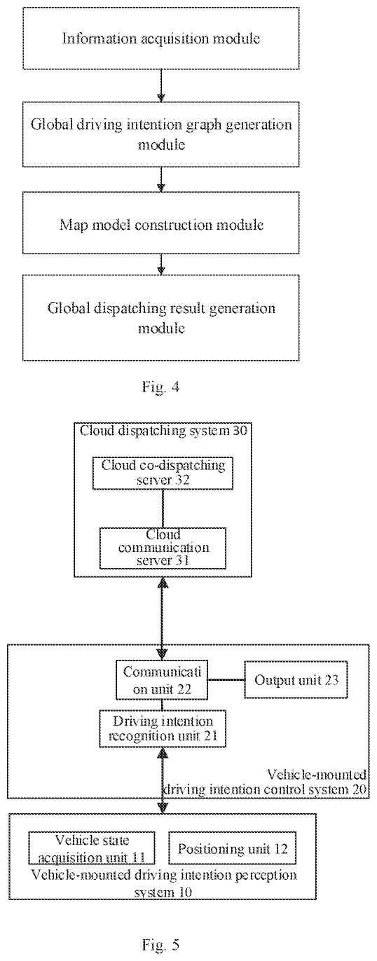

The present embodiment discloses a system for regionally co-dispatching driving intentions of intelligent vehicles. Based on the system of the present embodiment, the method for regionally co-dispatching driving intentions of intelligent vehicles described in Embodiment 1 can be implemented. As shown in FIG. 5, the system for regionally co-dispatching driving intentions of intelligent vehicles of the present embodiment includes a cloud dispatching system 30, and a vehicle-mounted driving intention perception system 10 and a vehicle-mounted driving intention control system 20 disposed on a vehicle.

The vehicle-mounted driving intention perception system is connected to the vehicle-mounted driving intention control system, and is configured to acquire state information and position information of the vehicle and transmit the acquired state information and position information of the vehicle to the vehicle-mounted driving intention control system.

In the present embodiment, the vehicle-mounted driving intention perception system 10 includes a vehicle state acquisition unit 11 and a positioning unit 12.

The vehicle state acquisition unit 11 is configured to acquire the state information of the vehicle, including an accelerator pedal state, steering wheel angle, brake pedal state, and absolute speed of the vehicle.

The positioning unit 12 is configured to acquire the position information of the vehicle, including GPS longitude information and GPS latitude information of the vehicle.

The vehicle-mounted driving intention control system is connected to the cloud dispatching system in a wireless manner, and is configured to recognize a driving intention of the vehicle according to the state information of the vehicle, and transmit the driving intention information of the vehicle and the state information and position information of the vehicle to the cloud dispatching system.

In the present embodiment, the vehicle-mounted driving intention control system 20 includes a driving intention recognition unit 21, a communication unit 22 and an output unit 23.

The driving intention recognition unit 21 is configured to acquire the driving intention of the vehicle recognized according to the state information of the vehicle. The process of recognizing, by the driving intention recognition unit, the driving intention of the vehicle according to the state information of the vehicle in the present embodiment may be as follows:

A driving intention recognition model is constructed based on a convolutional neural network (CNN). Vehicle state information is taken as an input quantity I of the driving intention recognition model, and a recognition vector W=(w1, w2, w3, w4, w5) for the driving intentions is output by a Softmax layer of the driving intention recognition model, where w1, w2, w3, w4, and w5 are probabilities of driving intention categories: traveling to a left lane, keeping unchanged, traveling to a right lane, speeding up, and slowing down, respectively.

Confidence thresholds for various driving intention categories are set, the acquired current vehicle state information is input into the driving intention recognition model, and when an output probability of a certain driving intention category is greater than the corresponding confidence threshold, it is determined that a vehicle has a driving intention C corresponding to the category, where

C∈{Ca: traveling to a left lane, Cb: keeping unchanged, Cc: traveling to a right lane, Cd: speeding up, Cf: slowing down}.

In the present embodiment, the confidence thresholds for the driving intention categories: traveling to a left lane and traveling to a right lane may be set as 80%, the confidence threshold for the driving intention category: keeping unchanged may be set as 70%, and the confidence thresholds for the driving intention categories: speeding up and slowing down may be set as 80%.

The communication unit 22 is configured to transmit the driving intention information of the vehicle and the state information and position information of the vehicle to the cloud dispatching system. In the present embodiment, the communication unit may be a wireless communication module disposed on the vehicle, including a 4G communication module, a 5G communication module, etc. The communication unit may upload information corresponding to the vehicle-mounted driving intention control system to the cloud dispatching system through a mobile communication base station. In the present embodiment, the vehicle-mounted driving intention control system uploads information O=[C, V, W, P] to the cloud dispatching system through the communication unit, where C is the recognized driving intention, V is the vehicle absolute speed in the vehicle state information S, W is the steering wheel angle in the vehicle state information S, and P is the vehicle position information.

The output unit 23 is configured to receive a global dispatching result of driving intentions of driving dispatching area vehicles transmitted by the cloud dispatching system, whereby a vehicle driving decision system guides driving decisions of the vehicle according to the dispatching result. In the present embodiment, the output unit is connected to the communication unit, and acquires a global dispatching result of driving intentions of dispatching area vehicles from the cloud dispatching system through the communication unit, the vehicle driving decision system is a system installed on the vehicle to control the vehicle to travel, and the vehicle decision system can control the vehicle to perform a corresponding motion according to the driving intention of the vehicle.

The cloud dispatching system 30 is configured to perform the method for regionally co-dispatching driving intentions of intelligent vehicles described in Embodiment 1.

In the present embodiment, the cloud dispatching system 30 includes a cloud communication server 31 and a cloud co-dispatching server 32.

The cloud co-dispatching server is configured to perform the method for regionally co-dispatching driving intentions of intelligent vehicles described in Embodiment 1 as follows:
acquiring state information and position information of vehicles;
acquiring driving intention information of the vehicles recognized by the state information of the vehicles;
generating a global driving intention graph of all the vehicles within a dispatching area range according to the driving intention information of the vehicles within the dispatching area range, the state information of the vehicles and the position information of the vehicles;
constructing a dispatching area occupancy grid map model; and
co-dispatching global driving intentions of the vehicles within the area range according to the constructed dispatching area occupancy grid map model, and generating a global dispatching result of driving intentions of dispatching area vehicles.

The specific operation process of the above content is described in Embodiment 1, and detailed descriptions thereof will be omitted herein.

The cloud communication server is configured to communicate with the communication unit in the vehicle-mounted driving intention control system, receive the driving intention information of the vehicle and the state information and position information of the vehicle transmitted by the vehicle-mounted driving intention control system, and transmit the global dispatching result of driving intentions of driving dispatching area vehicles to the vehicle-mounted driving intention control system.

### Embodiment 4

The present embodiment discloses a storage medium storing a program which, when executed by a processor, implements the method for regionally co-dispatching driving intentions of intelligent vehicles described in Embodiment 1 as follows:
acquiring state information and position information of vehicles;
acquiring driving intention information of the vehicles recognized by the state information of the vehicles;
generating a global driving intention graph of all the vehicles within a dispatching area range according to the driving intention information of the vehicles within the dispatching area range, the state information of the vehicles and the position information of the vehicles;
constructing a dispatching area occupancy grid map model; and
co-dispatching global driving intentions of the vehicles within the area range according to the constructed dispatching area occupancy grid map model, and generating a global dispatching result of driving intentions of dispatching area vehicles.

The specific operation process of the above content is described in Embodiment 1, and detailed descriptions thereof will be omitted herein.

In the present embodiment, the storage medium may be a magnetic disk, an optical disk, a computer memory, a read-only memory (ROM), a random access memory (RAM), a U disk, a removable hard disk, or the like.

### Embodiment 5

The present embodiment discloses a computing device, including a processor and a memory for storing a program executable by the processor. The processor, when executing the program stored in the memory, implements the method for regionally co-dispatching driving intentions of intelligent vehicles described in Embodiment 1 as follows:
acquiring state information and position information of vehicles;
acquiring driving intention information of the vehicles recognized by the state information of the vehicles;
generating a global driving intention graph of all the vehicles within a dispatching area range according to the driving intention information of the vehicles within the dispatching area range, the state information of the vehicles and the position information of the vehicles;
constructing a dispatching area occupancy grid map model; and
co-dispatching global driving intentions of the vehicles within the area range according to the constructed dispatching area occupancy grid map model, and generating a global dispatching result of driving intentions of dispatching area vehicles.

The specific operation process of the above content is described in Embodiment 1, and detailed descriptions thereof will be omitted herein.

In the present embodiment, the computing device may be a terminal device such as a desktop computer, a notebook computer, a smart phone, a PDA handheld terminal, or a tablet computer.

In summary, the present disclosure aims at a scenario in which multiple drivers change driving intentions at the same time in a human-vehicle co-driving mode, which is likely to cause conflict between the driving intentions of the vehicles within adjacent area ranges. The driving intentions of all the vehicles within the area range are co-dispatched, and a global dispatching order is generated to guide driving decisions of the vehicles. On the one hand, the risk of collision of the vehicles is avoided, thereby improving the driving safety. On the other hand, the overall traffic efficiency within an area range is also improved.

The above embodiments are preferred implementations of the present disclosure, but the implementations of the present disclosure are not limited by the above embodiments. Any other changes, modifications, substitutions, combinations, and simplifications made without departing from the spirit and principles of the present disclosure are to be construed as equivalent substitutions within the protection scope of the present disclosure.

1. A method for regionally co-dispatching driving intentions of intelligent vehicles, comprising:
acquiring state information and position information of vehicles;
acquiring driving intention information of the vehicles recognized by the state information of the vehicles;
generating a global driving intention graph of all the vehicles within a dispatching area range according to the driving intention information of the vehicles within the dispatching area range, the state information of the vehicles and the position information of the vehicles;
constructing a dispatching area occupancy grid map model; and
co-dispatching global driving intentions of the vehicles within the area range according to the constructed dispatching area occupancy grid map model, and generating a global dispatching result of driving intentions of dispatching area vehicles, so as to guide driving decisions of the vehicles within the dispatching area range by means of the global dispatching result of driving intentions of dispatching area vehicles.

2. The method for regionally co-dispatching driving intentions of intelligent vehicles according to claim 1, wherein the process of recognizing the driving intentions of the vehicles through the state information and position information of the vehicles comprises:
constructing a driving intention recognition model based on a convolutional neural network, wherein vehicle state information is taken as an input quantity I of the driving intention recognition model, and a recognition vector w=(w1, w2, w3, w4, w5) for the driving intentions is output by a Softmax layer of the driving intention recognition model, where w1, w2, w3, w4, and w5 are probabilities of driving intention categories: traveling to a left lane, keeping unchanged, traveling to a right lane, speeding up, and slowing down, respectively; and
setting confidence thresholds for various driving intention categories, and when an output probability of a certain driving intention category is greater than the corresponding confidence threshold, determining that a vehicle has a driving intention (corresponding to the category, where
C∈{Ca: traveling to a left lane, Cb: keeping unchanged, Cc: traveling to a right lane, Cd: speeding up, Cf: slowing down}.

3. The method for regionally co-dispatching driving intentions of intelligent vehicles according to claim 1, wherein the generating a global driving intention graph of all the vehicles within a dispatching area range is: G=G=[gᵢ], 1≤i≤N, N is a total number of vehicles within the dispatch area range, where gᵢ=(Cᵢ, Vᵢ, Wᵢ, Pᵢ), and Cᵢ, Vᵢ, Wᵢ, Pᵢ are the driving intention, absolute speed, steering angle, and vehicle position information of an i^{th} vehicle within the dispatching area range, respectively.

4. The method for regionally co-dispatching driving intentions of intelligent vehicles according to claim 3, wherein the process of generating the global dispatching result of driving intentions of dispatching area vehicles comprises:
Sa, representing position information Pᵢ of each vehicle i within the dispatching area range with point coordinates based on the dispatching area occupancy grid map model, 1≤i≤N, mapping into a corresponding cell of an occupancy grid, identifying a cell mapped with vehicle position information as occupancy, and identifying a cell not mapped with vehicle position information as vacancy;
Sb, calculating a longitudinal displacement S′ᵢ=(Vᵢtₛ+1/2=aₛtₛ²) cos(Wᵢ) and a lateral displacement S′ᵢ=(Vᵢtₛ+1/2=aₛtₛ²) sin(Wᵢ) of each vehicle i within a safe acceleration aₛ and a safe time tₛ according to the driving intention Cᵢ, absolute speed Vᵢ and steering wheel angle Wᵢ of each vehicle i within the dispatching area, and determining predicted position information Pᵢ^{ts} of the vehicle i according to the longitudinal displacement S′ᵢ and the lateral displacement S′ᵢ, 1≤i≤N;
Sc, acquiring a prediction state according to the predicted position information Pᵢ^{ts} of each vehicle i within the dispatching area for each cell in the dispatching area;
Sd, predicting, based on the prediction state of each cell, whether the driving intentions of the vehicles conflict in the cell, specifically:
determining whether the prediction state of each cell is occupancy by multiple vehicles, when the prediction state of a cell is occupancy by a vehicle, namely, when the cell is predicted to be occupied by a vehicle, predicting that the driving intentions of the vehicle do not conflict in the cell, and controlling the vehicle predicted to occupy the cell to travel according to the driving intentions thereof;
when the prediction state of a cell is occupancy by multiple vehicles, namely, when the cell is predicted to be occupied by multiple vehicles, predicting that the driving intentions of the vehicle conflict in the cell, and proceeding to step Se;
Se, determining whether the multiple vehicles predicted to occupy the cell have a driving intention: keeping unchanged;
if yes, setting the driving intentions of all the vehicles predicted to occupy the cell as: keeping unchanged;
if no, randomly selecting a vehicle from the multiple vehicles predicted to occupy the cell to travel according to the driving intention thereof, and setting the driving intentions of the other vehicles as: keeping unchanged;
Sf, determining the driving intentions of the vehicles within the dispatching area based on the above operations, and generating a dispatching result.

5. An apparatus for regionally co-dispatching driving intentions of intelligent vehicles, comprising:
an information acquisition module, configured to acquire state information and position information of vehicles, and acquire driving intentions of the vehicles recognized by the state information and position information of the vehicles;
a global driving intention graph generation module, configured to generate a global driving intention graph of all the vehicles within a dispatching area range according to the driving intention information of the vehicles within the dispatching area range, the state information of the vehicles and the position information of the vehicles;
a map model construction module, configured to construct a dispatching area occupancy grid map model; and
a global dispatching result generation module, configured to co-dispatch global driving intentions of the vehicles within the area range according to the constructed dispatching area occupancy grid map model, and generate a global dispatching result of driving intentions of dispatching area vehicles, so as to guide driving decisions of the vehicles within the dispatching area range by means of the global dispatching result of driving intentions of dispatching area vehicles.

6. A system for regionally co-dispatching driving intentions of intelligent vehicles, comprising: a cloud dispatching system, and a vehicle-mounted driving intention perception system and a vehicle-mounted driving intention control system disposed on a vehicle, wherein
the vehicle-mounted driving intention perception system is connected to the vehicle-mounted driving intention control system, and is configured to acquire state information and position information of the vehicle and transmit the acquired state information and position information of the vehicle to the vehicle-mounted driving intention control system;
the vehicle-mounted driving intention control system is connected to the cloud dispatching system in a wireless manner, and is configured to recognize a driving intention of the vehicle according to the state information of the vehicle, and transmit the driving intention information of the vehicle and the state information and position information of the vehicle to the cloud dispatching system; and
the cloud dispatching system is configured to perform the method for regionally co-dispatching driving intentions of intelligent vehicles according to claim 1.

7. The system for regionally co-dispatching driving intentions of intelligent vehicles according to claim 6, wherein the vehicle-mounted driving intention perception system comprises a vehicle state acquisition unit and a positioning unit;
the vehicle state acquisition unit is configured to acquire the state information of the vehicle, comprising an accelerator pedal state, steering wheel angle, brake pedal state, and absolute speed of the vehicle; and
the positioning unit is configured to acquire the position information of the vehicle, comprising GPS longitude information and GPS latitude information of the vehicle.

8. The system for regionally co-dispatching driving intentions of intelligent vehicles according to claim 6, wherein the vehicle-mounted driving intention control system comprises a driving intention recognition unit, a communication unit and an output unit;
the driving intention recognition unit is configured to acquire the driving intention of the vehicle recognized according to the state information of the vehicle;
the communication unit is configured to transmit the driving intention information of the vehicle and the state information and position information of the vehicle to the cloud dispatching system;
the output unit is configured to receive a global dispatching result of driving intentions of driving dispatching area vehicles transmitted by the cloud dispatching system, whereby a vehicle driving decision system guides driving decisions of the vehicle according to the dispatching result;
the cloud dispatching system comprises a cloud communication server and a cloud co-dispatching server;
the cloud co-dispatching server is configured to perform the method for regionally co-dispatching driving intentions of intelligent vehicles according to claim 1; and
the cloud communication server is configured to communicate with the communication unit in the vehicle-mounted driving intention control system, receive the driving intention information of the vehicle and the state information and position information of the vehicle transmitted by the vehicle-mounted driving intention control system, and transmit the global dispatching result of driving intentions of driving dispatching area vehicles to the vehicle-mounted driving intention control system.

9. A storage medium storing a program which, when executed by a processor, implements the method for regionally co-dispatching driving intentions of intelligent vehicles according to claim 1.

10. A computing device, comprising a processor and a memory for storing a program executable by the processor, wherein the processor, when executing the program stored in the memory, implements the method for regionally co-dispatching driving intentions of intelligent vehicles according to claim 1.
